(19) United States
(12) Patent Application Publication
(10) Pub. No.: US 2024/0249261 A1
(43) Pub. Date: Jul. 25, 2024

(54) ACCOUNT STRUCTURE WITH INTERACTIONS TRIGGERED BY DETECTED CHANGES IN THE ACCOUNTS

(71) Applicant: Goldman Sachs & Co. LLC, New York, NY (US)

(72) Inventors: Gurjit Jagpal, Radlett (GB); Matthias Paetzold, Rayleigh (GB); Mark Perkin, London (GB); David Moore Goldman, Santa Monica, CA (US); Ayturk B. Markowitz, New York, NY (US)

(21) Appl. No.: 18/217,330

(22) Filed: Jun. 30, 2023

Related U.S. Application Data
(60) Provisional application No. 63/440,328, filed on Jan. 20, 2023.

(51) Int. Cl. G06Q 20/10; G06Q 20/40; G06Q 40/02

(52) U.S. Cl. CPC G06Q 20/108; G06Q 20/4037; G06Q 40/02

(57) ABSTRACT

A payor account is monitored to detect when it receives assets sufficient to meet the payor's current obligations under a deal. When this condition is met, assets sufficient to meet the obligation are transferred from the payor account to an intermediary virtual account. Similarly, the intermediary account is monitored for whether it contains sufficient assets to meet an obligation to a payee under the deal. When this condition is met, sufficient assets to meet this obligation are transferred from the intermediary account to the payee account.

### CROSS-REFERENCE TO RELATED APPLICATIONS

This application claims the benefit of U.S. Provisional Patent Application No. 63/440,328, filed Jan. 20, 2023, which is incorporated by reference.

### BACKGROUND

Financial institutions operate large and complex financial processing systems to facilitate payments between entities. One type of payment facilitated by such systems is loan payments between borrowers and lenders. Because creating and maintaining physical accounts can involve significant overhead in the form of costs, time, and paperwork (e.g., opening a new physical account can take several weeks), financial institutions that act as agents facilitating loan servicing typically receive loan payments and make loan payments from a shared account in which all activity for an entity, region, and currency are pooled. Because of the large amount of payments that may be made in a day, the shared account may have a large credit limit (e.g., billions of dollars) and any outgoing payments can be made based on the overall liquidity of the shared account, with incoming payments being often manually matched against expected activity for the shared account.

There are two significant problems with this approach. First, the large credit limit of the shared accounts allows for large overpayments and unintentional fronting. If an error is made, payments that are orders of magnitude larger than the amount due can be completed, and such overpayments or unintentional fronting may be difficult or impossible to claw back legally or operationally. Second, matching incoming or outgoing payments to expected activity with such a large volume of transactions is a complex problem. The transaction matching requires significant computation resources and is prone to failures that may result in incorrect payments being made or intended payments not occurring.

### SUMMARY

The above and other problems are addressed by a computer system and method in which a virtual account structure is used to manage interactions between accounts relating to deals. Intermediary virtual accounts are created for each deal and linked to one or more virtual accounts for payors and payees associated with the deal. For example, an intermediary virtual account may be created for each deal (also referred to as a “deal virtual account”). At one end of the structure, one or more payor virtual accounts can be assigned assets that were wired to an agent's physical account from payor physical account and attributed to the corresponding payor's virtual account (e.g., the wire can be to an account number assigned to the payor's virtual account, which is mapped to the agent's physical account for the purposes of the wire transfer). At the other end of the structure, one or more payee virtual accounts can be attributed assets, still within the agent's physical account, which may then be wired to corresponding payee physical accounts.

In one embodiment, a payor virtual account is monitored to detect when it receives assets sufficient to meet the payor's current obligations under the deal. When this condition is met, assets sufficient to meet the obligation are transferred from the payor virtual account to the deal virtual account. Similarly, the deal virtual account is monitored for whether it contains sufficient assets to meet an obligation to a payee under the deal. When this condition is met, sufficient assets to meet this obligation are transferred from the deal virtual account to the payee virtual account, and then on to a physical account of the payee.

### BRIEF DESCRIPTION OF THE DRAWINGS

FIG. 1 is a block diagram of a networked computing environment suitable for providing automatically triggered interactions between virtual accounts, according to one embodiment.

FIG. 2 is a block diagram illustrating one embodiment of the financial institution system of FIG. 1.

FIG. 3A illustrates an account structure for distributing loan payments, according to one embodiment.

FIG. 3B illustrates an account structure for providing funding to a borrower, according to one embodiment.

FIG. 3C illustrates an account structure for fronting funding to a borrower by an agent, according to one embodiment.

FIG. 3D illustrates an account structure for lenders to repay a fronting agent, according to one embodiment.

FIG. 3E illustrates an account structure that includes a mechanism for handling mismatches between received funds and corresponding obligations, according to one embodiment.

FIG. 3F illustrates an account structure for an agent to make tax withholdings, according to one embodiment.

FIG. 4 is a flowchart illustrating a method for using automatically triggered interactions between virtual accounts to facilitate a payment, according to one embodiment.

FIG. 5 is a block diagram illustrating an example computer suitable for use in the networked computing environment of FIG. 1, according to one embodiment.

### DETAILED DESCRIPTION

Reference will now be made to several embodiments, examples of which are illustrated in the accompanying figures. Wherever practicable, similar or like reference numbers are used in the figures to indicate similar or like functionality. Where similar elements are identified by a reference number followed by a letter, a reference to the number alone in the description that follows may refer to all such elements, any one such element, or any combination of such elements. One skilled in the art will readily recognize from the following description that alternative embodiments of the structures and methods may be employed without departing from the principles described.

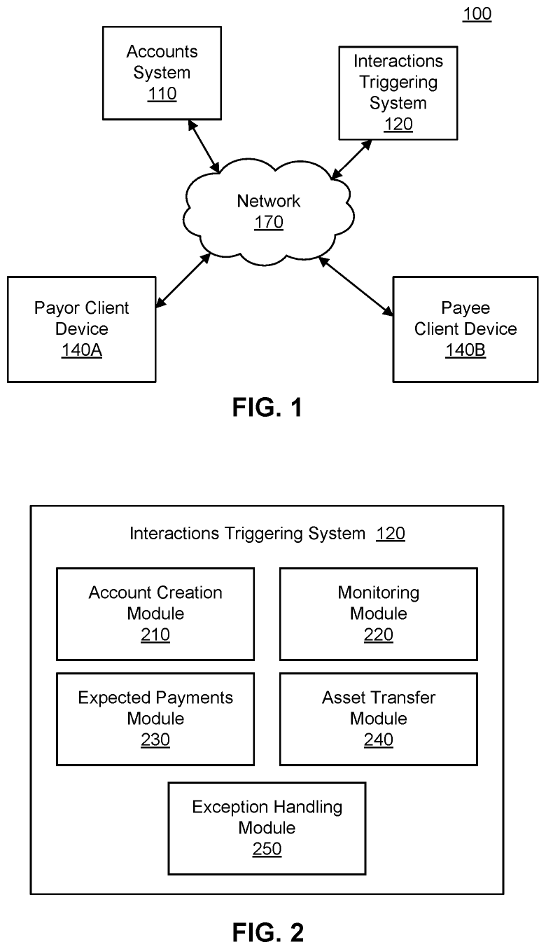

FIG. 1 illustrates one embodiment of a networked computing environment 100 suitable for providing automatically triggered interactions between virtual accounts. In the embodiment shown, the networked computing environment 100 includes an accounts system 110, an interactions triggering system 120, a payor client device 140A, and a payee client device 140B, all connected via a network 170. In other embodiments, the networked computing environment 100 contains different or additional elements. In addition, the functions may be distributed among the elements in a different manner than described. For example, the functionality of the accounts system 110 and the interactions triggering system 120 may be provided by a single financial institution computing system. Furthermore, although the accounts system 110 and the interactions triggering system 120 are shown as single entities for convenience, the corresponding functionality may be provided by multiple networked computing devices.

The accounts system 110 is typically managed by a financial institution and includes one or more computing devices that provide accounts for entities (e.g., borrowers, lenders, and agents). In one embodiment, the accounts system 110 provides transaction banking services. Entities have accounts with the accounts system 110 that may hold value (e.g., fiat currency, cryptocurrency, stocks, bonds, or any other asset). The accounts include physical accounts and virtual accounts. Physical accounts are conventional accounts with a financial institution in which the account holder holds assets. Virtual accounts provide a way to subdivide an underlying physical account into parts such that it behaves like multiple accounts. Each virtual account has an account identifier (e.g., an account number) and the accounts system 110 maintains a record of assets held by the virtual account, while the assets themselves are held by the underlying physical account. The account system may maintain virtual accounts for credit agreements (deals) that are held by the financial institution that operates the accounts system 110 and that are used as intermediary steps in transactions relating to the deals. In some embodiments, some or all of the virtual accounts may be implemented using a distributed ledger (e.g., as smart contracts on a blockchain). Furthermore, the accounts provided by the accounts system 110 may interact with external accounts provided by other systems and financial institutions.

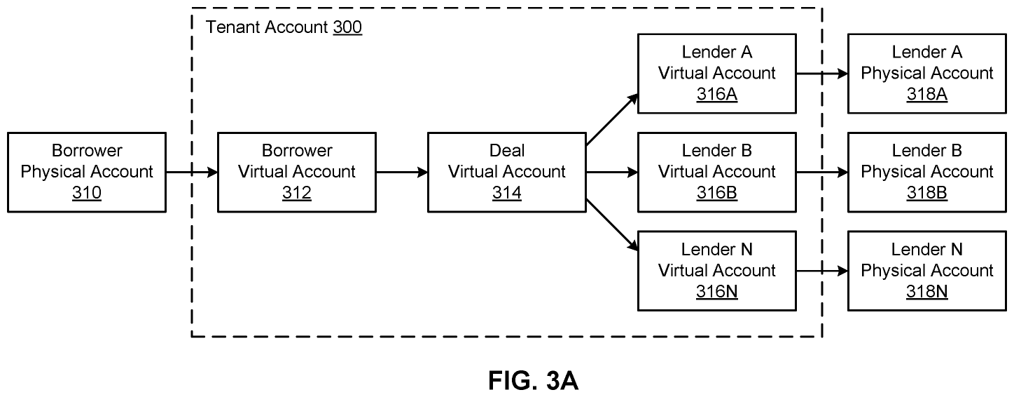

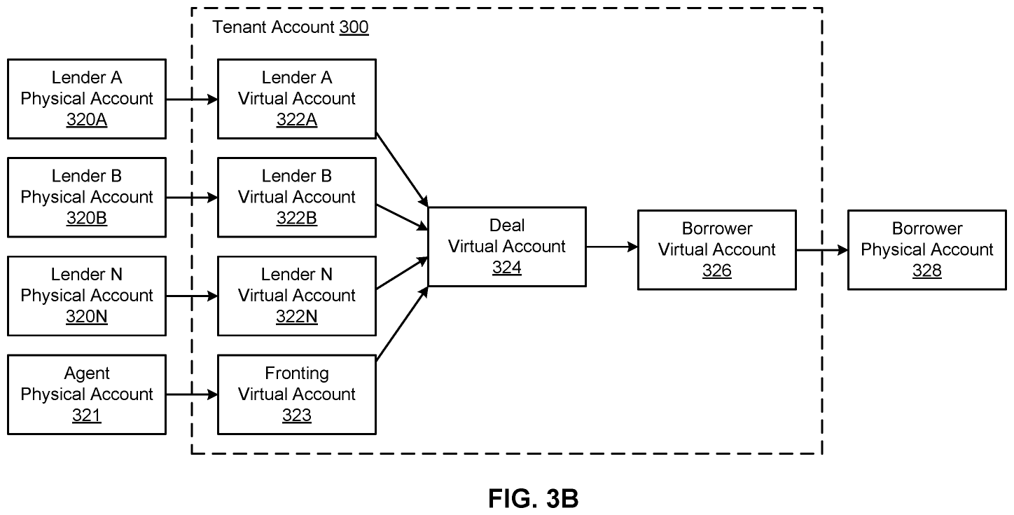

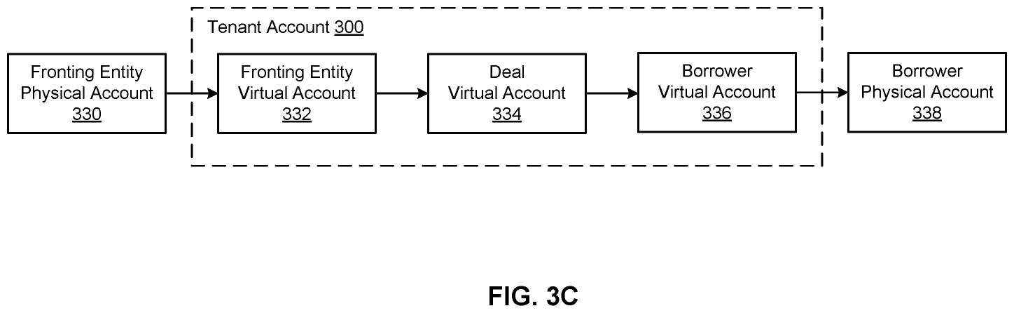

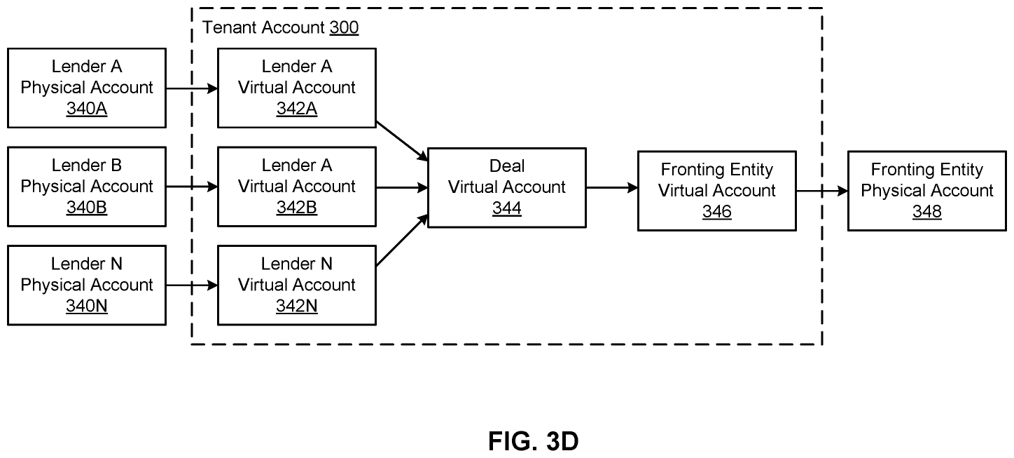

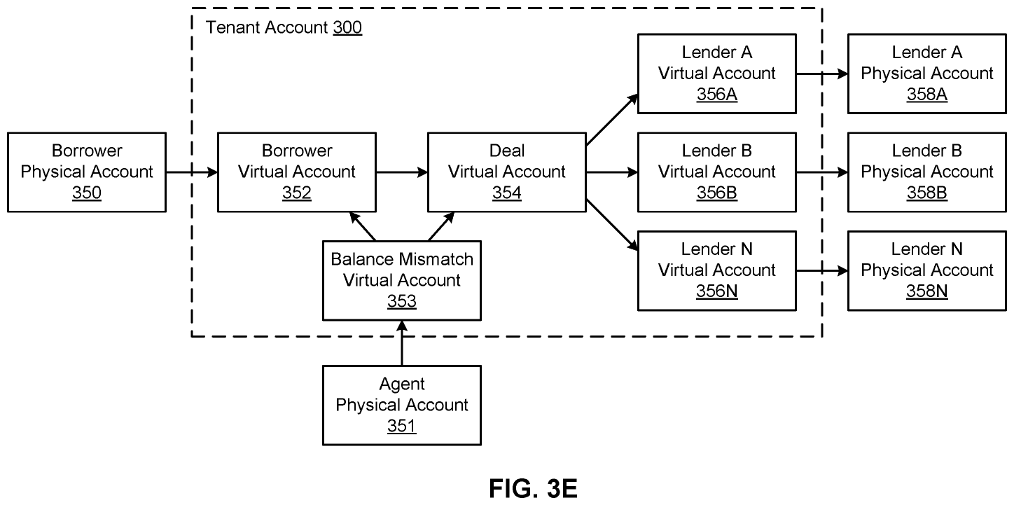

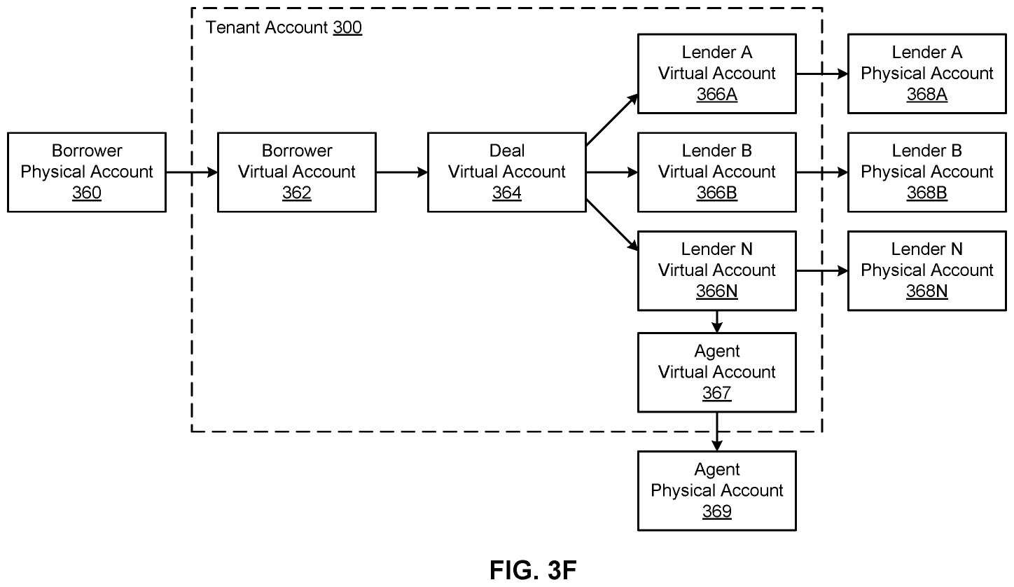

The interactions triggering system 120 monitors the assets held in accounts managed by the accounts system 110 and triggers interactions if one or more conditions are met. In one embodiment, the interactions triggering system 120 monitors virtual accounts for expected assets to be used in meeting an obligation (e.g., making a payment such as an interest or loan payment) and initiates a transfer of the expected assets once the assets are detected. Such interactions can be chained in arbitrarily complex structures of virtual accounts to account for a wide range of scenarios where value is transferred between numerous entities. Various embodiments of the interactions triggering system 120 and various virtual account structures are described in greater detail below, with reference to FIGS. 2 and 3A-D. Although these embodiments are described as using virtual accounts, the same or similar approaches may be applied using account structures in which some or all of the accounts are physical accounts.

The client devices 140 are computing devices with which users interact with the accounts system 110 or interactions triggering system 120. For example, the client devices 140 may be desktop computers, laptop computers, tablets, smartphones, or the like, with which the user accesses functionality of the accounts system 110 or interactions triggering system 120 via the network 170 using a web browser or dedicated application. The client devices 140 may interact with the other elements of the networked computing environment 100 using an application programming interface (API). Although FIG. 1 shows to client devices 140 (a payor client device 140A used by a user that is transferring value to a payee and a payee client device 140B used by the payee that is receiving the value from the payor), the networked computing environment 100 can include any number of such devices (and will typically include many more).

The network 170 may include any combination of local area and wide area networks employing wired or wireless communication links. In one embodiment, network 170 uses standard communications technologies and protocols. For example, network 130 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 130 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any format, such as hypertext markup language (HTML) or extensible markup language (XML). Some or all of the communication links of the network 170 may be encrypted.

FIG. 2 illustrates one embodiment of the interactions triggering system 120. In the embodiment shown, the interactions triggering system 120 includes an account creation module 210, a monitoring module 220, an expected payments module 230, an asset transfer module 240, and an exception handling module 250. In other embodiments, the interactions triggering system 120 contains different or additional elements. In addition, the functions may be distributed among the elements in a different manner than described.

The account creation module 210 handles the creation of virtual accounts to service various interactions. In one embodiment, the account creation module 210 requests the creation of new virtual accounts with the accounts system 110 via an API. The request for a new virtual account for a physical account may include information for the account, such as an account number to transfer assets from external payee/payor physical account, an identifier of the payor/payee entity it is affiliated with, a purpose for and type of the account (e.g., a deal the account will be used for and the role of the account within the deal), and an identifier of the corresponding physical account. Alternatively, the request may identify an entity and purpose and the accounts system 110 may use that information to select a corresponding physical account (e.g., a physical account registered for an identified agent that will service a loan).

In one embodiment, each loan agent entity serviced by the accounts system 110 has a physical account, referred to as a tenant account, that is a deposit account that can hold assets. Each tenant account may have the following virtual accounts, each of which has segregated liquidity and separate settlement instructions: one or more client accounts (accounts corresponding to a payor or a payee), one or more deal accounts, and one or more agent accounts. The tenant account of a loan agent may include a separate client virtual account for each borrower and lender serviced by the loan agent and a dedicated virtual account for each deal that is not shared with any other deal. A tenant account may also include one or more agent virtual accounts that collect fees, withhold taxes, and provide liquidity to handle balance mismatches, etc. Various example account structures that may be used to facilitate different types of transaction and described in greater detail below, with reference to FIGS. 3A-D.

The monitoring module 220 monitors the assets held by accounts to detect changes. In one embodiment, the monitoring module 220 periodically (e.g., every twenty seconds, every minute, every fifteen minutes, every hour, etc.) polls the accounts system 110 for updates regarding account assets. The accounts system 110 may return any changes (e.g., changes in account balances) or the assets held by accounts, which the monitoring module 220 may then compare to the assets indicated as held by the account in response to a previous poll. Alternatively, the monitoring module 220 may subscribe to accounts (e.g., using an API) and the accounts system pushes an update (e.g., in a webhook) to the monitoring module when the assets held by a subscribed account change. This latter method can significantly reduce the amount of network traffic between the accounts system 110 and the interactions triggering system 120, reducing network congestion. Regardless of the precise mechanism used, the monitoring module 220 identifies changes in the assets held by virtual accounts.

The expected payments module 230 tracks obligations of virtual accounts for deals. In one embodiment, the expected payments module 230 maintains a list of payment obligations of each virtual account per time period (e.g., per day). When the monitoring module 220 determines that a virtual account has received assets, the expected payments module compares the assets received to current obligations to other virtual accounts and if the assets received are sufficient to meet one or more obligations, the assets are transferred on to the virtual account to which the obligation is due. For example, a payor's monthly payment on a loan (a deal) is due and an amount of money matching (or approximately matching) the amount of the monthly payment is received in the payor's virtual account, the monthly payment may be made to a virtual account for the deal. The monitoring module 220 in turn detects the receipt of the money in the deal virtual account, which may trigger a transfer of the money to the virtual accounts of one or more payees. The money may ultimately be transferred to the payees with a wire transfer from the tenant account of the agent to the physical account of the payees, at which time the balances of the payees' virtual accounts within the tenant account are also updated to reflect the wire transfer.

The asset transfer module 240 sends instructions (e.g., via an API) to the accounts system to initiate transfers between accounts based on the outputs from the monitoring module 220 and the expected payments module 230. In instances where assets are received in a virtual account that has more than one obligation, various approaches may be adopted to determining which obligations are met and in what order. In one embodiment, no action is taken until the virtual account has sufficient assets to meet all of its obligations for a current time period, at which point, all of the obligations are met by dividing up and distributing the assets accordingly. In another embodiment, received assets are matched to specific obligations based on value. Because each payor/payee entity has its own virtual account, this matching problem is significantly less complex than the matching that is performed by conventional systems in which the assets received for all transactions of all payor/payee entities are aggregated in a single, physical account.

In yet another embodiment, rules may be defined that assign how and in what order obligations are met. For example, if a payor has two loans, rules may be created that specify the senior loan is paid first and the junior loan is paid second, in which case, any received assets will first be applied to the senior loan and only applied to the junior loan once that obligation has been met. As another example, rules may distribute received assets proportionally among obligations or using any other distribution that is agreed to by the deal participants. As a further example, rules may allow for a certain amount of shortfall (either in relative or absolute terms) such that if the amount present in an account is short of the obligated amount by less the allowable shortfall, a transfer to meet the obligation (less the shortfall) is initiated (also referred to as a make-whole transfer). This can be particularly useful in cases where currency conversion is occurring and the received amounts may not exactly match the obligated amounts or where received amounts are being split between multiple payees and there may be rounding errors. For example, the virtual account structure may include one or more balance mismatch virtual accounts that hold a pool of assets that can be used to make up a shortfall (or temporarily hold overpayments). These balance mismatch virtual accounts may be funded from an agent physical account separate from the tenant account. As yet another example, the accounts system 110 may provide metadata with account balance updates that identifies a particular deal (e.g., using a deal ID) that the payment was intended for (e.g., as provided by the payor when submitting the payment using a portal, API, or other user interface).

In some embodiments, the risk of erroneous payments may be further reduced using rules that limit the types of transfers allowable into and out of virtual accounts. These rules can identify instructions that are inconsistent with the purposes of the various virtual accounts in the virtual account structure. For example, a wire transfer listing a payor or payee account number that is a deal virtual account may be rejected. Deal virtual accounts may be limited to receiving payments from and making payments to other virtual accounts. As another example, client virtual accounts may be prevented from making transfers to other client virtual accounts. Rather, a client virtual account may be limited to transferring assets to another client virtual account via a deal virtual account. Transactions identified as erroneous may be disallowed or flagged for human review/approval.

The exception handling module 250 addresses exceptions that arise. In one embodiment, if at the end of a time period (e.g., the end of a day), a virtual account includes assets that are not tied to any obligation, the exception handling module 250 determines what to do with those assets. For example, the exception handling module 250 may trigger transfers of assets from a deal account back to the payor/payee virtual account that provided them, use the assets to partially meet an existing obligation, or generate an alert to a human operative that unexpected assets are present in the account and should be addressed. Additionally or alternatively, the exception handling module 250 may generate alerts if assets that are expected to meet an obligation have not been received in a virtual account by a predetermined time. For example, if a loan payment is due by 5 pm from a payor virtual account to a deal account, and the payor virtual account does not include sufficient assets to meet the obligation by 3 pm, an alert may be sent to a user associated with the payor virtual account (e.g., via email, text message, or push notification, etc.).

FIGS. 3A-F illustrate various account structures that may be used to facilitate various types of transaction. It should be appreciated that other account structures are possible to support a broad range of deal and payment structures. These account structures are provided by way of example to illustrate practical application of the principles disclosed above.

FIG. 3A illustrates an account structure for distributing loan payments, according to one embodiment. In this structure, a single borrower has obtained a loan under a deal with multiple lenders. The borrower is making an interest or principal payment. The borrower has a borrower physical account 310 and each lender has a lender physical account 318A-N. Payment flows from the borrower physical account 310 to the lender physical accounts 318A-N via a virtual account structure within the tenant account 300.

The borrower makes a single payment from its physical account 310 to a borrower virtual account 312 in the virtual account structure, which may be implemented as a wire transfer from the borrower physical account 310 to the tenant account 300 that is credited to the borrower virtual account 312 in the virtual account structure. Once the payment is received in the borrower virtual account 312, the monitoring module 220 detects the change in available assets. The expected payments module 230 determines the updated balance is sufficient to meet the borrower's obligations to the deal and causes a transfer of assets from the borrower virtual account 312 to the deal virtual account 314. Similarly, the change in balance of the deal virtual account 314 is detected and, assuming the updated balance is sufficient to meet the expected obligations to the lenders (which it should be if everything is operating as intended), transfers are initiated to each of the lender virtual accounts 316A-N in whatever proportion was agreed upon for the deal. Finally, the change in balances of the lender virtual accounts 316A-N are detected, triggering a wire transfer of funds to the lenders' physical accounts 318A-N from the tenant physical account 300.

FIG. 3B illustrates an account structure for providing funding to a borrower, according to one embodiment. In the example shown, the funding is provided by multiple lenders, each of which has a lender physical account 320A-N. Each lender transfers value from its physical account 320 to a corresponding lender virtual account 322A-N, which is part of the virtual account structure for the deal that is associated with the tenant physical account 300. Value may also be injected into the virtual account structure by the agent bank from a different physical account of the agent 321 to a fronting virtual account 323.

When the interactions triggering system 120 determines that there are sufficient assets in lender A virtual account 322A to meet lender A's obligations under the deal, the requisite value is transferred from lender A's virtual account 322A to the deal virtual account 324. Similarly, value may be transferred from lender B virtual account 322B, lender N virtual account 322N, and fronting virtual account 323 to the deal virtual account 324 on a determination that each account has sufficient assets to meet the corresponding obligation under the deal. On a determination by the interactions triggering system 120 that the deal virtual account 324 contains sufficient assets to meet its obligations under the deal (e.g., the amount of the loan being issued), the corresponding value is transferred to the borrower's virtual account 326 and, in turn, wired to the borrower's physical account 328.

FIG. 3C illustrates an account structure for fronting funding to a borrower by an agent bank, according to one embodiment. Because the virtual account structures isolate funds to specific payors/payees and deals, accidental fronting is avoided. However, in some instances, entities may wish to intentionally front payments. In these scenarios, the fronting entity provides value into the virtual account structure from the fronting entity's physical account 330. Specifically, the provided assets are deposited into the fronting entity's virtual account 332. This value is detected and, assuming it is sufficient to meet the agreed upon fronting obligation, triggers a transfer from the fronting entity's virtual account 332 to the deal virtual account 334. On detecting that the agreed upon fronted amount has been paid into the deal virtual account 334, a transfer to of that amount to the borrower's virtual account 336 is initiated, which in turn triggers a wire payment of the agreed upon amount to the borrower's physical account 338.

FIG. 3D illustrates an account structure for lenders to repay a fronting agent, according to one embodiment. In the case where an entity has fronted a loan, the ultimate lenders agree upon the amount that each will pay back to the fronting entity as terms of the deal. Each lender transfers the corresponding agreed upon amount from the lender's physical account 340A-N to the lender's virtual account 342A-N in the virtual account structure. On detecting that the agreed upon amount has been deposited in a lender's virtual account 342A-N, a transfer is initiated of that amount to the deal virtual account 344. On detecting that the deal account 344 contains sufficient assets to meet the obligations to the fronting entity (e.g., when all of the lenders have met their obligations to the deal), a transfer is initiated to the fronting entity's virtual account 346, which in turn triggers a wire transfer to the fronting entity's physical account 348.

FIG. 3E illustrates an account structure that includes a mechanism for handling mismatches between received funds and corresponding obligations, according to one embodiment. FIG. 3E shows a deal structure similar to that shown in FIG. 3A. Assets are wired from a borrower physical account 350 to the tenant account 300 and attributed to borrower virtual account 352. A balance mismatch virtual account 353 is also funded from an agent physical account 351. If the balance detected in the borrower virtual account 352 has a shortfall with regard to an obligation of the borrower virtual account to a deal account 354 within a pre-specified threshold, a transfer is initiated from the balance mismatch virtual account 353 to the borrower virtual account 352 to compensate for the shortfall. The obligation is then met with a transfer of the obligated amount from the borrower virtual account 352 to the deal virtual account 354. Alternatively, the balance of the borrower virtual account 352 may be transferred to the deal virtual account 354 and the shortfall amount transferred directly from the balance mismatch virtual account 353 to the deal virtual account 354. Similarly, if the balance of the deal virtual account 354 is detected to be sufficient to meet obligations to one or more lender virtual accounts 356A-N, transfers are initiated from the deal virtual account to the lender virtual accounts, with the balance mismatch virtual account 353 meeting shortfalls within a threshold tolerance. Regardless of the precise mechanisms used, assets may be extracted from the virtual account structure via wire transfers from the tenant account 300 to one or more lender physical accounts 358A-N, and the balances of the corresponding lender virtual accounts 356A-N updated accordingly.

FIG. 3F illustrates an account structure to enable tax withholdings or payment of fees, according to one embodiment. FIG. 3F shows a deal structure similar to that shown in FIG. 3A. Assets are wired from a borrower physical account 360 to the tenant account 300 and attributed to a borrower virtual account 362. If the balance of the borrower virtual account 362 is sufficient to meet an obligation to a deal virtual account 364, assets are transferred from the borrower virtual account 362 to the deal virtual account 364 to meet the obligation. Similarly, if the balance of the deal virtual account 364 is detected to be sufficient to meet obligations to one or more lender virtual accounts 366A-N, transfers are initiated from the deal virtual account to the lender virtual accounts. When balances are detected in one or more lender virtual accounts 366A-N, a portion of those assets may be transferred to an agent virtual account 367. The transferred portion of assets may be extracted from the virtual account structure via a wire transfer from the tenant physical account 300 to a different physical account of the agent 369. The portion of assets transferred out of the lender virtual accounts 366A-N may be used to meet various obligations of the lenders, such as withholding for tax purposes, payment of fees to the agent, or the like. Regardless of the precise mechanisms used, the remaining assets in the lender virtual accounts 366A-N may be extracted from the virtual account structure via wire transfers from the tenant account 300 to one or more lender physical accounts 368A-N, and the balances of the corresponding lender virtual accounts 366A-N updated accordingly.

### Example Methods

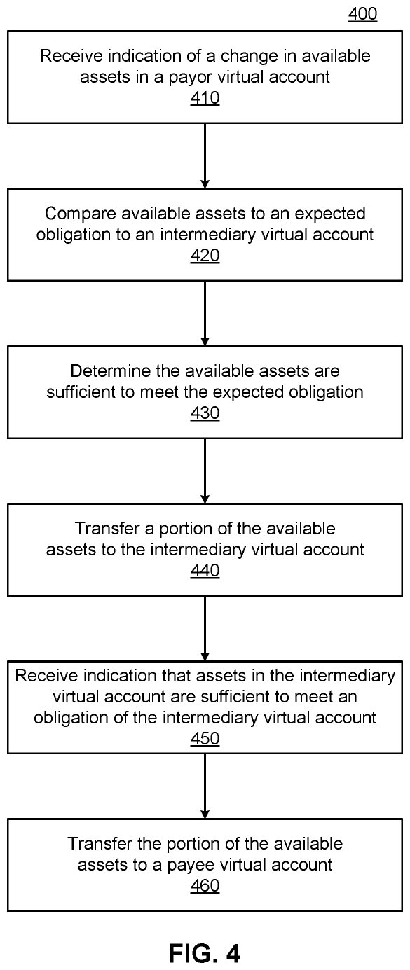

FIG. 4 illustrates an example method 400 for using automatically triggered interactions between virtual accounts to facilitate a payment, according to one embodiment. The steps of FIG. 4 are illustrated from the perspective of the interactions triggering system 120 performing the method 400. However, some or all of the steps may be performed by other entities or components. In addition, some embodiments may perform the steps in parallel, perform the steps in different orders, or perform different steps.

In the embodiment shown in FIG. 4, the method 400 begins with the interactions triggering system 120 receiving 410 an indication of the available assets in a payor virtual account. As described previously, this indication can be obtained via period polling (a pull technique) or generated by the accounts system 110 in response to a change in held assets (a push technique).

The interactions triggering system 120 compares 420 the available assets in the payor virtual account to an expected obligation to a deal virtual account. The interactions triggering system 120 determines 430 whether the available assets are sufficient to meet the expected obligation. If so, a portion of the assets is transferred 440 to the deal virtual account. In the case where the received assets exactly match the obligation, the portion of assets transferred may (and often will be) the total amount of assets held in the payor virtual account at that time.

The interactions triggering system 120 receives 450 an indication that the assets in the deal virtual account are sufficient to meet an obligation of the deal virtual account. For deals where there is a single payor, this may occur immediately on receiving the transfer of the portion of assets from the payor virtual account. Conversely, where there are multiple payors, this may occur when all contributions to the obligation of the deal virtual account have been received from the payor virtual accounts of all of the payors. In response to receiving 450 the indication that the assets in the deal virtual account are sufficient to meet the obligation of the deal virtual account, the portion of assets (and any other assets required to meet or substantially the obligation) are transferred 460 to a receiver virtual account. As described previously, in some implementations, the deal virtual account may have obligations to multiple receiver virtual accounts with rules being applied to determine how and in what order to meet these obligations.

### Computing System Architecture

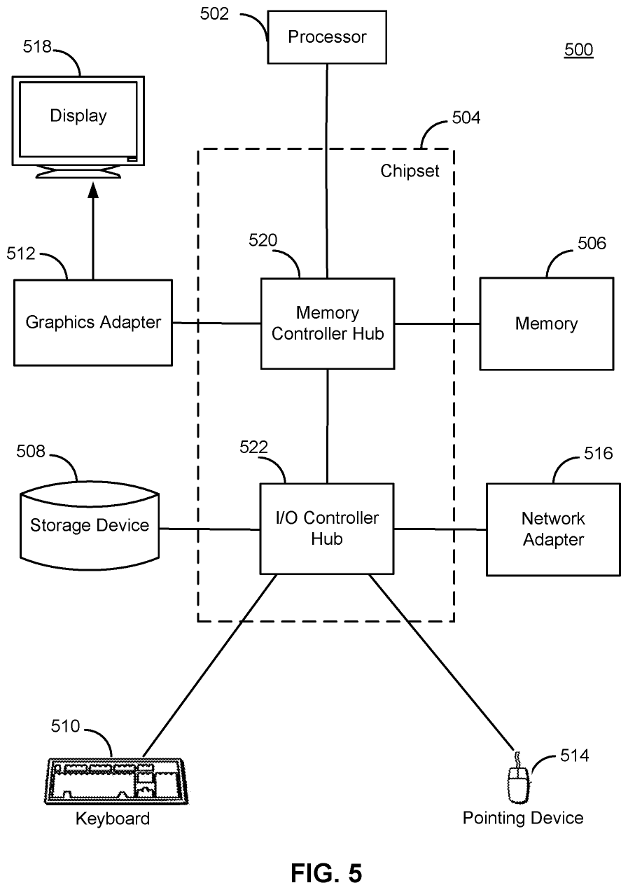

FIG. 5 is a block diagram illustrating an example computer 500 suitable for use as an accounts system 110, an interactions triggering system 120, or a client device 140. The example computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, keyboard 510, pointing device 514, and network adapter 516 are coupled to the I/O controller hub 522. Other embodiments of the computer 500 have different architectures.

In the embodiment shown in FIG. 5, the storage device 508 is a non-transitory computer-readable storage medium such as a hard drive, compact disk read-only memory (CD-ROM), DVD, or a solid-state memory device. The memory 506 holds instructions and data used by the processor 502. The pointing device 514 is a mouse, track ball, touch-screen, or other type of pointing device, and is used in combination with the keyboard 510 (which may be an on-screen keyboard) to input data into the computer system 500. The graphics adapter 512 displays images and other information on the display 518. The network adapter 516 couples the computer system 500 to one or more computer networks (e.g., network 170).

The types of computers used by the entities of FIGS. 1 and 2 can vary depending upon the embodiment and the processing power required. For example, the accounts system 110 might include a distributed database system comprising multiple blade servers working together to provide the functionality described. Furthermore, the computers can lack some of the components described above, such as keyboards 510, graphics adapters 512, and displays 518.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

While particular embodiments and applications have been illustrated and described, it is to be understood that the described subject matter is not limited to the precise construction and components disclosed. The scope of protection should be limited only by any claims that ultimately issue.

What is claimed is:

1. A computer-implemented method of automatically triggering interactions between accounts, the method comprising:
receiving a first indication of a change in available assets in a payor account;
responsive to receiving the first indication, comparing the available assets in the payor account to a first expected obligation of the payor account, the first expected obligation of the payor account identifying an intermediary account to which assets are to be transferred;
responsive to the available assets being sufficient to meet the first expected obligation, transferring an intended portion of the available assets to the intermediary account; and
responsive to receiving a second indication that assets held in the intermediary account are sufficient to meet a second expected obligation of the intermediary account, transferring the intended portion of the assets in the intermediary account to a payee account.

2. The computer-implemented method of claim 1, wherein receiving the first indication of the change in available assets in the payor account comprises:
periodically polling an accounts system for a balance of the payor account;
receiving a response to one instance of the periodic polling indicating that a current balance of the payor account is different than a previous balance of the payor account.

3. The computer-implemented method of claim 2, wherein the periodic polling occurs at a time interval in a range from ten seconds to ten minutes.

4. The computer-implemented method of claim 1, wherein receiving the first indication of the change in available assets in the payor account comprises receiving a pushed notification from an accounts system indicating a current balance of the payor account has changed.

5. The computer-implemented method of claim 4, wherein the pushed notification is a webhook.

6. The computer-implemented method of claim 1, wherein the second expected obligation comprises the intended portion of the assets received from the payor account and additional assets received from one or more additional payor accounts.

7. The computer-implemented method of claim 1, wherein the second expected obligation is to the payee account and one or more additional payee accounts, and one or more additional portions of the available assets are transferred to the one or more additional payee accounts.

8. The computer-implemented method of claim 1, wherein the second indication indicates that the assets held in the intermediary account differ than the second expected obligation by no more than a threshold.

9. The computer-implemented method of claim 1, further comprising responsive to the available assets being insufficient to meet the first expected obligation within a tolerance level, transferring make-whole assets from an agent account to the payor account or the intermediary account, wherein the available assets and the make-whole assets are collectively sufficient to meet the first expected obligation.

10. The computer-implemented method of claim 1, wherein the payor account, the intermediary account, and the payee account are virtual accounts.

11. A non-transitory computer-readable medium comprising instructions for automatically triggering interactions between accounts, the instructions, when executed by a computing system, causing the computing system to perform operations including:
receiving a first indication of a change in available assets in a payor account;
responsive to receiving the first indication, comparing the available assets in the payor account to a first expected obligation of the payor account, the first expected obligation of the payor account identifying an intermediary account to which assets are to be transferred;
responsive to the available assets being sufficient to meet the first expected obligation, transferring an intended portion of the available assets to the intermediary account; and
responsive to receiving a second indication that assets held in the intermediary account are sufficient to meet a second expected obligation of the intermediary account, transferring the intended portion of the assets in the intermediary account to a payee account.

12. The non-transitory computer-readable medium of claim 11, wherein receiving the first indication of the change in available assets in the payor account comprises:
periodically polling an accounts system for a balance of the payor account;
receiving a response to one instance of the periodic polling indicating that a current balance of the payor account is different than a previous balance of the payor account.

13. The non-transitory computer-readable medium of claim 12, wherein the periodic polling occurs at a time interval in a range from ten seconds to ten minutes.

14. The non-transitory computer-readable medium of claim 11, wherein receiving the first indication of the change in available assets in the payor account comprises receiving a pushed notification from an accounts system indicating a current balance of the payor account has changed.

15. The non-transitory computer-readable medium of claim 14, wherein the pushed notification is a webhook.

16. The non-transitory computer-readable medium of claim 11, wherein the second expected obligation comprises the intended portion of the assets received from the payor account and additional assets received from one or more additional payor accounts.

17. The non-transitory computer-readable medium of claim 11, wherein the second expected obligation is to the payee account and one or more additional payee accounts, and one or more additional portions of the available assets are transferred to the one or more additional payee accounts.

18. The non-transitory computer-readable medium of claim 11, wherein the second indication indicates that the assets held in the intermediary account differ than the second expected obligation by no more than a threshold.

19. The non-transitory computer-readable medium of claim 11, wherein the operations further include, responsive to the available assets being insufficient to meet the first expected obligation within a tolerance level, transferring make-whole assets from an agent account to the payor account or the intermediary account, wherein the available assets and the make-whole assets are collectively sufficient to meet the first expected obligation.

20. The non-transitory computer-readable medium of claim 11, wherein the payor account, the intermediary account, and the payee account are virtual accounts.
